(19) United States
(12) Patent Application Publication
(10) Pub. No.: US 2023/0419151 A1
(43) Pub. Date: Dec. 28, 2023

(54) METHODS AND APPARATUSES FOR MULTIPURPOSE LIGHT COLLECTION FOR REMOTELY ENTANGLING ATOMIC QUANTUM COMPUTERS IN A MULTI-CORE ARCHITECTURE

(71) Applicant: IonQ Quantum Canada, Inc., College Park, MD (US)

(72) Inventors: David SPIERINGS, Toronto (CA); IIia Khait, Toronto (CA); Aharon Brodutch, Toronto (CA)

(21) Appl. No.: 18/339,786

(22) Filed: Jun. 22, 2023

Related U.S. Application Data
(60) Provisional application No. 63/366,874, filed on Jun. 23, 2022.

(51) Int. Cl. G06N 10/40; G06N 10/80

(52) U.S. Cl. CPC G06N 10/40; G06N 10/80

(57) ABSTRACT

Aspects of the present disclosure relate generally to systems and methods for use in the implementation and/or operation of quantum information processing (QIP) systems, and more particularly, to systems and methods for receiving a readout beam associated with a state of a first qubit of an array of trapped ions, receiving an interconnect beam configured entangle a second qubit of the array with an external qubit of an external array, receiving an addressing beam, from an addressing unit, configured to control a state of a third qubit of the array, guiding, via at least one switch, the addressing beam from the addressing unit toward the third qubit, guiding, via the at least one switch, the readout beam toward a photodetector, and guiding, via the at least one switch, the interconnect beam toward an interconnect unit optically coupled with the external array.

### CROSS REFERENCE TO RELATED APPLICATIONS

The present application claims priority to U.S. Patent Provisional Application No. 63/366,874, filed Jun. 23, 2022, the entire contents of which are hereby incorporated by reference.

### TECHNICAL FIELD

Aspects of the present disclosure relate generally to systems and methods for use in the implementation and/or operation of quantum information processing (QIP) systems, and more particularly, to operations of multiple QIP systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In some aspects of the present disclosure, a switch/interconnect may be used to implement remote entangling of qubits. The interconnect beams used to entangle the remote qubits may traverse substantially the same paths as the readout beam and/or the addressing beam. The switch/interconnect may be used to separate the readout beam, the interconnect beam, and/or the addressing beam and guide them toward different optical components. The readout beam may be guided toward the readout device. The interconnect beam may be guided toward the remote qubit.

Aspects of the present disclosure includes systems and methods for receiving a readout beam associated with a state of a first qubit of an array of trapped ions, receiving an interconnect beam configured to entangle a second qubit of the array with an external qubit of an external array, receiving an addressing beam, from an addressing unit, configured to control a state of a third qubit of the array, guiding, via at least one switch, the addressing beam from the addressing unit toward the third qubit, guiding, via the at least one switch, the readout beam toward a photodetector, and guiding, via the at least one switch, the interconnect beam toward an interconnect unit optically coupled with the external array.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions in a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example of a QPU network according to aspects of the present disclosure.

FIG. 5 illustrates an example of a viewport according to some aspects of the present disclosure.

FIGS. 6A-C illustrate example configurations of trapped ions in a QPU according to some aspects of the present disclosure.

FIG. 7 illustrates an example of states of a trapped ion of a QPU according to aspects of the present disclosure.

FIG. 8 illustrates an example of an interconnect-enabled system according to aspects of the present disclosure.

FIG. 9 illustrates a functional diagram of the interconnect-enabled system according aspects of the present disclosure.

FIGS. 10A-C illustrate example schemes for multiplexing beams according to aspects of the present disclosure.

FIG. 11 illustrates an example of overlap of adjacent atoms according to aspects of the present disclosure.

FIG. 12 illustrates an example of atomic configurations and waveguide spacings according to aspects of the present disclosure.

FIG. 13 illustrates an example of operation for routing an interconnect beam by the second switch according to aspects of the present disclosure.

FIGS. 14A-B illustrate example implementations of interferometers and/or beam splitters as part of the entanglement generation according to aspects of the present disclosure.

FIG. 15 illustrates a method of implementing remote entanglement of multiple QPUs according to aspects of the present disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well known components.

Quantum computing (QC) is a method for processing information that utilizes quantum two-level systems or quantum bits (qubits) as the fundamental unit of information storage. QC furthermore leverages entanglement between qubits, natively generated in many QC platforms, to perform computations with fewer resources (e.g. computation time, number of bits, etc.) than classical computing schemes. Within a quantum computer, quantum processing units (QPUs) can be apportioned by the subset(s) of qubits between which entanglement can be deterministically generated and thereby quantum gates carried out directly. Building large QPUs may be a challenging task with numerous technical obstacles specific to the particular quantum system used as a platform for the computation. An alternative approach for scaling QC is to interconnect multiple smaller QPUs, each individually with limited computational power, but, when linked, has the computational capacity of a much larger device.

The technological challenges to scaling QC are tightly linked to the computing platform in which qubits are encoded. In atomic systems, qubits are intrinsically identical and many systems naturally have good connectivity between qubits within a QPU. The primary difficulty in scaling these platforms is the technological overhead involved in increasing QPU size while maintaining QPU performance, most notably gate fidelities and gate times. Thus, what is lacking is the technological implementation that would make QC in atomic systems viable.

A modular approach to scale QC in atomic systems circumvents the need for a large number of qubits in a single QPU by connecting smaller QPUs. One exemplary aspect include utilizing optical interconnects, also known as photonic links, to herald entanglement across distant QPUs.

Exemplary aspects of the present disclosure include the optical hardware configured to implement a multi-QPU approach to atomic QC. Three fundamental operations in a multi-QPU approach to atomic QC may utilize high numerical aperture optical access to the atoms including one or more of: (1) individual addressing of optical qubits, (2) spatially resolve qubit readout, and/or (3) fluorescent collection for heralding remote entanglement as in an optical interconnect. Given the limitations on optical access to atoms inside a vacuum chamber, it may be advantageous to perform all three of these operations through a single high numerical aperture viewport.

Aspects of the present disclosure include a design for optics that enable optical paths for the operations indicated above, while maintaining the independence of degrees of freedom necessary for their functions (e.g. wavelength, polarization). Another aspect includes few avenues to separate these optical paths that utilize either the temporal, spatial, or frequency degrees of freedom of the light.

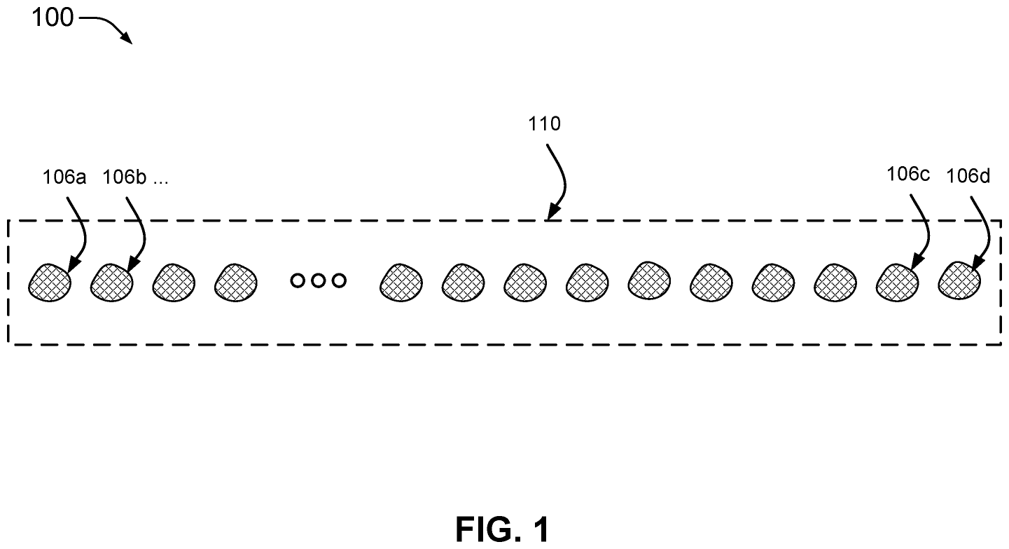

Solutions to the issues described above are explained in more detail in connection with FIGS. 1-15, with FIGS. 1-3 providing a general configuration of QIP systems or quantum computers, and more specifically, of atomic-based QIP systems or quantum computers.

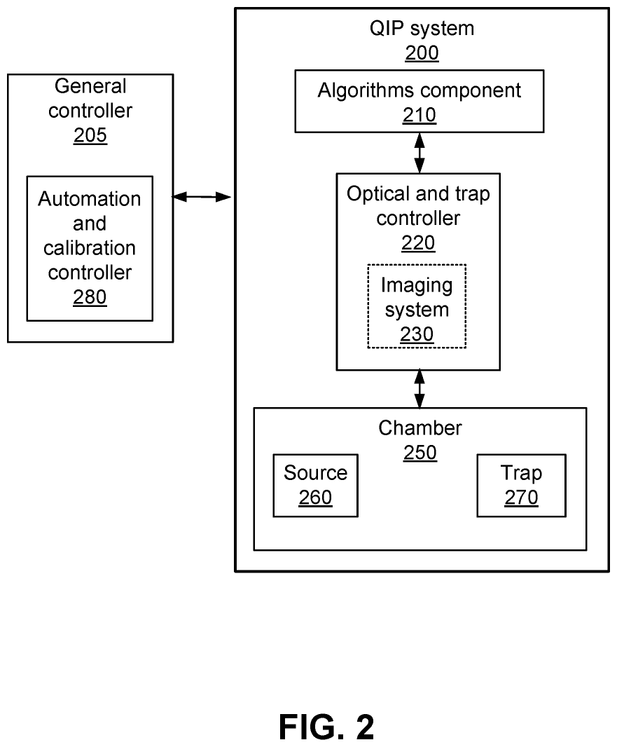

FIG. 1 shown below illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be Ytterbium ions (e.g., ¹⁷¹Yb⁺ ions), for example. The atomic ions are illuminated with laser (optical) radiation tuned to a resonance in ¹⁷¹Yb⁺ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions and/or neutral atoms, for example, with an ion trap being one example of such a confinement device. The ion trap may be a surface trap, for example.

FIG. 2 shown below is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250. For example, optical systems within the chamber 250 may refer to optical components or optical assemblies.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

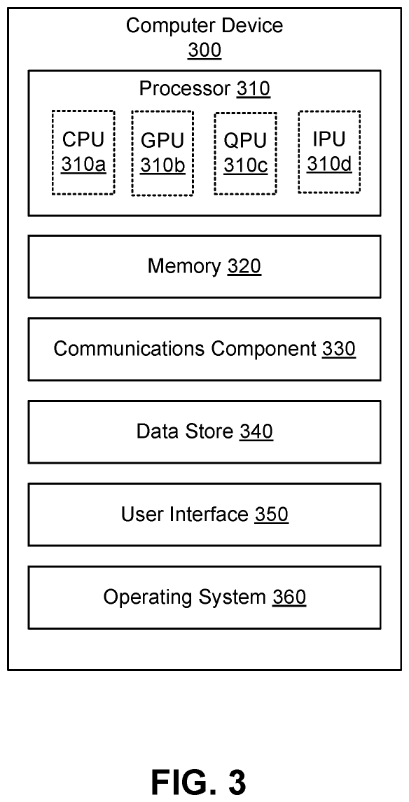

Referring now to FIG. 3 shown below, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, aspects of the present disclosure include an interconnect system configured to entangle a plurality QPUs disposed remotely from one another. The systems described in FIGS. 2-3 may be used to control various aspects of the interconnect system as described below.

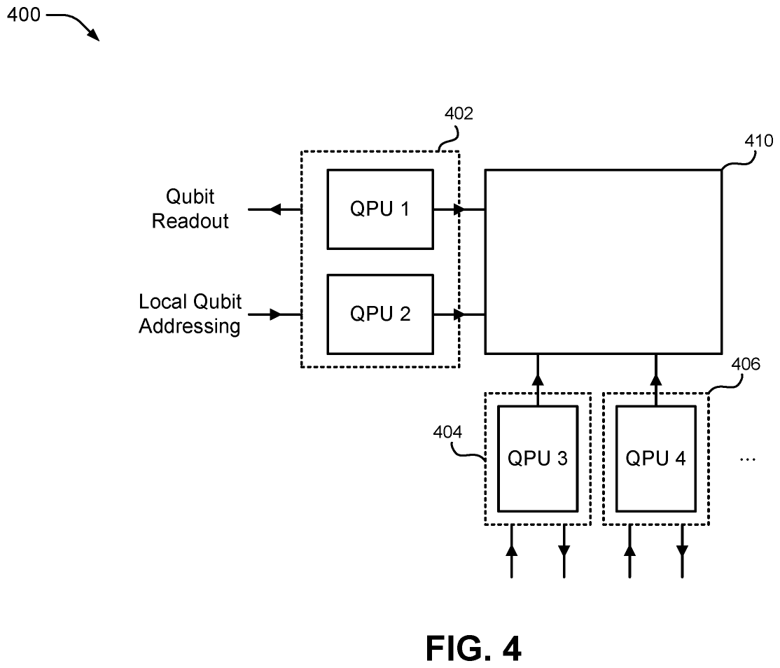

FIG. 4 illustrates an example of a QPU network 400 according to aspects of the present disclosure. Individual atoms confined in single or multi-dimensional arrays within a vacuum chamber may provide a promising platform for QC that also lends itself to an interconnected QPU network. Proposals for interconnecting atomic qubits probabilistically herald entanglement between “distant” atoms (i.e. ones that do not interact directly) upon detection of photons emitted from each atom. Thus, for interconnect operations in a multi-QPU QC architecture, the interconnect attempt may be repeated.

In some aspects, the QPU network 400 may include a first vacuum chamber 402 having a first processor QPU 1 and a second processor QPU 2. The QPU network 400 may include a second vacuum chamber 404 having a third processor QPU 3 and a fourth vacuum chamber 406 having a fourth processor QPU 4. Other numbers of vacuum chamber and/or processors may also be implemented. The QPU network 400 may include an optical switch 410 configured to provide one or more paths for entangling the qubits in the processors QPU 1, QPU 2, QPU 3, QPU 4 as described below.

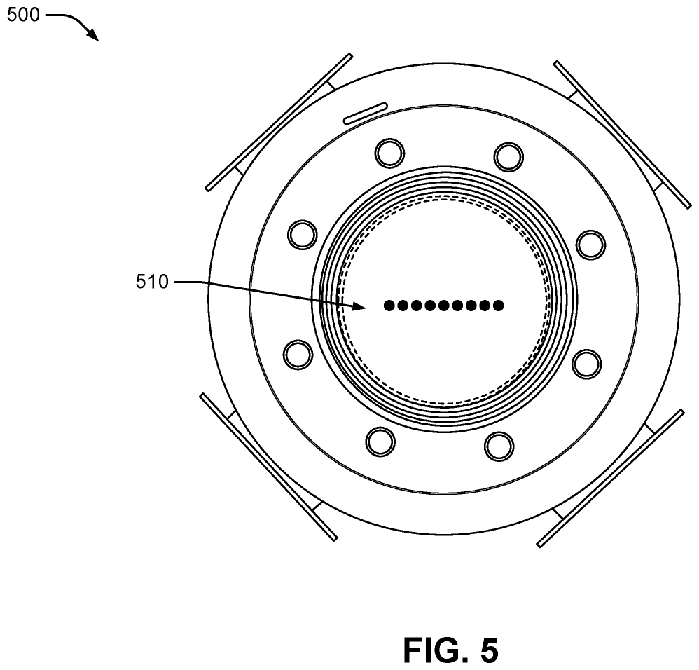

FIG. 5 illustrates an example of a viewport 500 according to some aspects of the present disclosure. As shown, the viewport illustrates an exemplary ion chain, such as ion chain 110 described above, as the linear row of ion 510 in FIG. 5. It is advantageous for the optics used to collect photons for interconnect operations to not interfere with other functions of the QC. Aspects of the present disclosure include a Light Collection Apparatus (LCA), for atomic quantum computing platforms that enables high-efficiency light collection for interconnect operations, while also permitting readout of qubit states and addressing of individual qubits for gate operations, through the same viewport of the vacuum system. Readout, addressing, and interconnect operations are the three functions of a multi-QPU atomic quantum computer that rely on high numerical aperture optical access. Aspects of the present disclosure facilitates these operations while utilizing a single viewport towards the atoms. Additionally, aspects of the present disclosure enable any-to-any connectivity between any QPU in the quantum network using a switch, which may operate on similar principles as the separation component in the LCA.

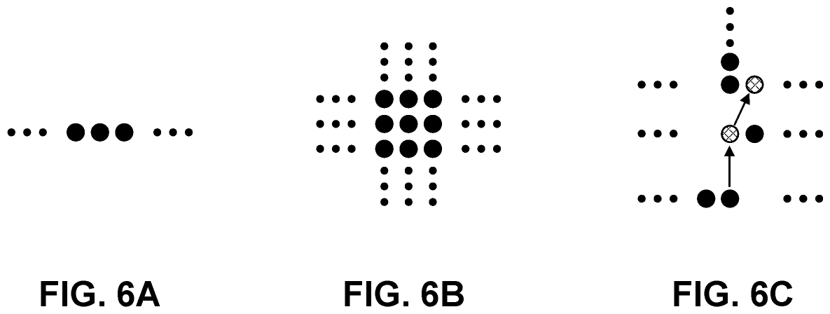

FIGS. 6A-C illustrate example configurations of trapped ions in a QPU, such as QPUs 1-4 as described above, according to some aspects of the present disclosure. Atomic quantum computers are composed of array(s) of atoms trapped inside a vacuum chamber. The size and dimensionality of atomic arrays may vary, but the separation between atoms in a single cluster may range from 1 to 10 μm. At these separations, physical interactions between atoms are significant and can be used to directly generate entanglement between a pair or among many atoms in the array. In the configuration shown in FIG. 6C, the ions may be shuffled, which allows for dynamic arrangement.

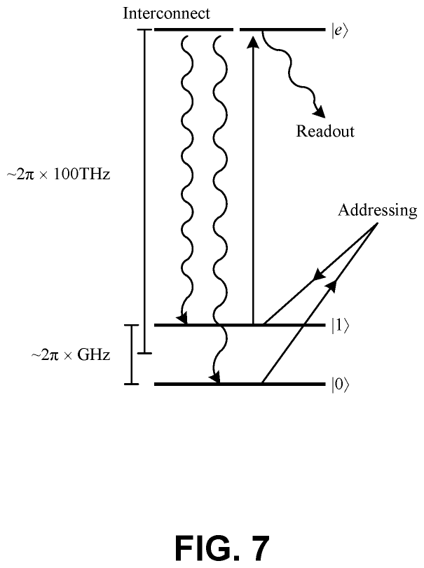

FIG. 7 illustrates an example of states of a trapped ion of a QPU according to aspects of the present disclosure. In one aspect, two energy levels of each atom in a QPU may be allocated to be the “zero” and the “one” states of the quantum bit. Light at certain optical frequencies is used to drive single and multi-qubit gates. This light is often focused down tighter than the typical distance between atoms, and thereby implement individual addressing of qubits. Ideally the addressing light should be focused such that it has a uniform intensity distribution across the region in which an atom can move within the trap and no cross-talk with a neighboring atom. These requirements may be achieved by an optical system with high-numerical aperture.

In some aspects, readout of qubit states in an atomic (e.g., trapped ion) quantum computer is typically achieved by driving one of the qubit states (e.g., state “1”) on a strong transition and collecting and imaging fluorescent light on a detector. For a high-fidelity readout of a computation, the optical system that collects fluorescent photons for qubit readout may have high collection efficiency, and a good spatial resolution so that the images of the atoms created at the detection plane do not have significant spatial overlap. A high efficiency imaging system with good spatial resolution may require optics with high numerical aperture access to the atoms.

In certain aspects, implementing remote entanglement across QPUs in an atomic quantum computer may require collecting fluorescent photons from atoms in distinct QPUs, which are not necessarily situated in the same vacuum chamber (as shown in FIG. 1). The frequency of these photons may or may not match that of the photons collected for qubit readout. For fast, high fidelity interconnect operations, high-efficiency photon collection into optical fibers or another photonic waveguides is required. When coupling fluorescent light from multiple atoms into different optics fibers, the optical system may be required to have high spatial resolution so that cross-talk between adjacent channels is minimized.

For flexibility of interconnecting different QPUs, photons collected for interconnect operations may be routed appropriately to create the proper link. Linked QPUs may be in the same vacuum chamber or in separate chambers. In either scenario, a switch may determine which QPUs to optically connect for enabling remote entanglement.

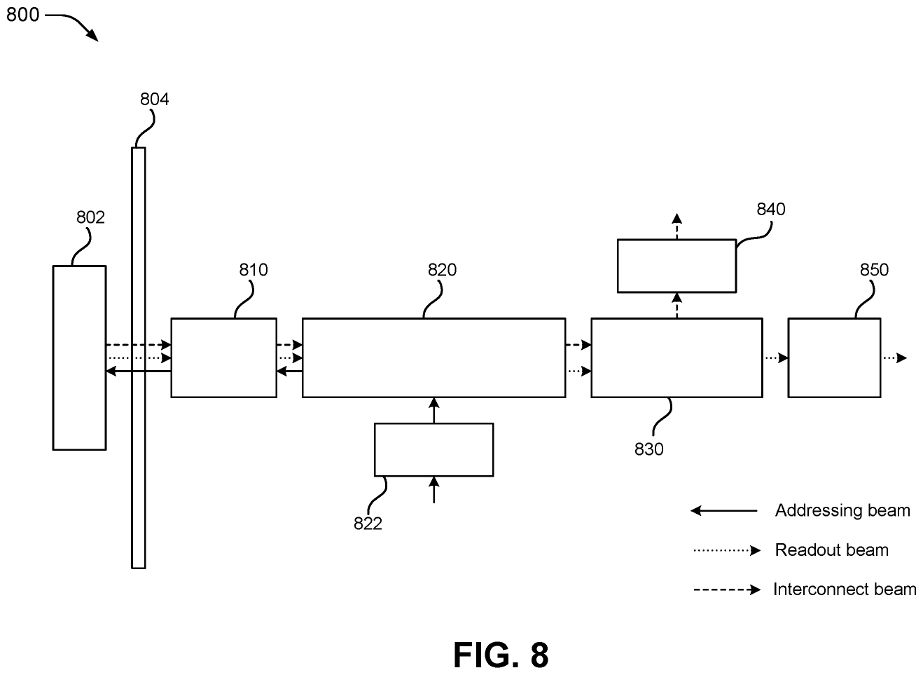

FIG. 8 illustrates an example of an interconnect system 800 according to aspects of the present disclosure. In some aspects, the interconnect system 800 may include one or more atomic arrays 802 including a plurality of trapped ions in a vacuum chamber (not shown), such as chamber 250 described above with respect to FIG. 2. The one or more atomic arrays 802 may include one or more QPUs. The states of the plurality of trapped ions may be used for implementing the qubit states of a QPU (not shown). The interconnect system 800 may include a vacuum chamber viewport 804 (e.g., such as the viewport 500) configured to provide an optical path to the one or more atomic arrays 802 while maintaining the pressure in the vacuum chamber (not shown). The viewport 804 may include one or more glass plates. The interconnect system 800 may include an optical component 810 (e.g., a microscope objective). The optical component 810 may be a multi-lens optic that is achromatic over the wavelength range spanned by interconnect, readout, and addressing operations (e.g., ranging from near infrared (IR) to near ultraviolet (UV)). The optical component 810 may be configured to correct for distortions introduced by the viewport 804.

In some aspects, the light for each primary function may be separated by two sequential components before being directed to units specific for each operation. Interconnect and readout units are intended as output paths that collect fluorescent light, whereas the addressing unit provides optical access to individual qubits for light directed toward the QPU.

In certain aspects, the interconnect system 800 may include a first switch 820 configured to separate the addressing beam from an addressing unit 822, and the readout beam and the interconnect beam. In particular, the first switch 820 may be configured to guide the addressing beam from the addressing unit 822 toward the optical component 810 and the one or more atomic arrays 802. The first switch 820 may be configured to guide the readout beam and the interconnect beam from the optical component 810 and the one or more atomic arrays 802 toward a second switch 830.

In some aspects, the interconnect system 800 may include the second switch 830 configured to separate the readout beam and the interconnect beam. The second switch 830 may guide the interconnect beam toward an interconnect unit 840 and the readout beam toward a readout unit 850. The interconnect unit 840 may be coupled with one or more waveguide arrays associated one or more QPUs. The readout unit 850 may be coupled with one or more photodetectors (e.g., the imaging system 230) configured to capture the readout beam.

In certain aspects, the interconnect beam may be guided toward the one or more QPUs, or to another switch, to enable entanglement across multiple QPUs.

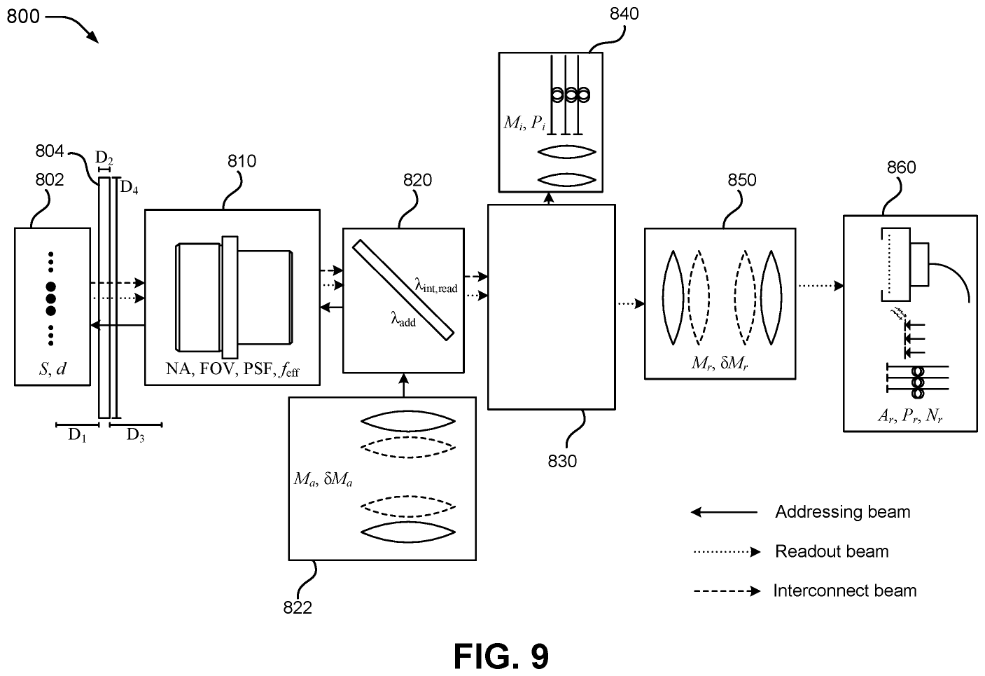

FIG. 9 illustrates a functional diagram of the interconnect system 800 according aspects of the present disclosure. In some aspects of the present disclosure, the one or more atomic arrays 802 inside the vacuum chamber are characterized by their full extent, S, and the inter-qubit separation, d, within a QPU. S, which includes the distance between QPUs in the same chamber, determines the necessary field-of-view of the LAC, whereas d specifies the required resolution of the LAC.

In some aspects, the optical component 810 may be characterized by its numerical aperture (NA), its field-of-view (FOV), its point-spread-function (PSF), and/or its effective focal length (f_{eff}). In order to image the qubits, the FOV must be at least as large as S. In order to address thel qubits individually the PSF of the objective across the entire FOV must indicate a resolution better than d (i.e. the distance between the first zeros of the Airy function image of a point source anywhere in the FOV should be less than d). The NA sets the solid angle over which fluorescent light can be collected from the atoms. The NA is fundamentally limited by the diameter of the viewport, D4, and the minimum working distance, which is the sum of D1, D2, and D3. Here, the optical component 810 may be a microscopy objective considered to be in an infinite-conjugate configuration.

In one aspect of the present disclosure, the first switch 820 may include a dichroic mirror in an exemplary aspect. The addressing beam may be separated from the readout beam and the interconnect beam by the dichroic mirror. The wavelength of the light used for addressing qubits, λ_{add}, may be in the near-IR. The fluorescent light collected for the readout and interconnect operations, λ_{int, read}, may be in the near-UV or visible regime. This separation of tens or hundreds of nanometers is sufficient for the thin-film interference of a dichroic mirror to efficiently isolate the addressing light.

In some aspects, the addressing unit 822 may include a variable magnification telescope, with average magnification Mₐ that is tunable by an amount δM_{α} that maps the image of the atoms onto an array of laser beams generated by a diffractive optic (not shown) and input to the addressing port of the LAC. According to an exemplary aspect the magnification is determined by the requirement that each addressing beam have significant overlap with only one atom. As the typical motion of atoms is very small, this condition is primarily set by the separation d. While the input beam size and separation of the addressing beams can be measured off-line, the separation between atoms is typically unknown until the system is built. The flexibility to optimize this mapping is thus afforded by the tunable magnification. In some aspects, variable telescope designs may provide the required magnification and tuning range, such as variable telescopes where only interior lenses need be translated to vary the magnification. In some implementations, the exterior dimensions of the addressing unit remain fixed while the magnification is tuned.

In certain aspects of the present disclosure, the second switch 830 may be configured to separate the readout beam and the interconnect beam using one or more schemes suitable for implementing entanglement. Examples of the schemes include frequency division multiplexing, space division multiplexing, and/or time division multiplexing. These solutions may be implemented individually or in combination in a given architecture. The schemes are described in more detail below.

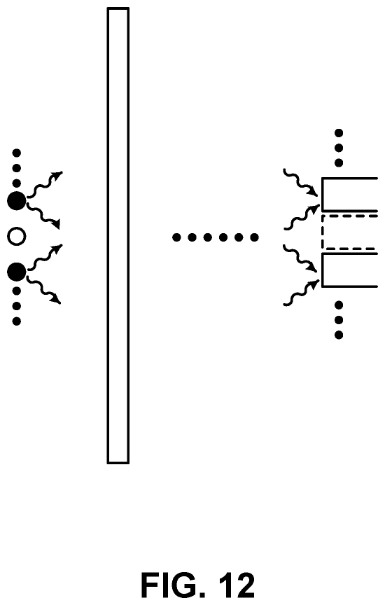

In some aspects of the present disclosure, the interconnect unit 840 may include one or more of fiber coupling lenses and/or a waveguide array to collect fluorescent light for implementing remote entanglement from the trapped ions of the one or more atomic arrays 802. Example implementations of the waveguide array include a bundle of single-mode fibers and rigid waveguide channels with micro-optics. The imaging magnification of the fiber coupling lenses (Me) is set to maximize the overlap between the image of the atoms and the mode-field diameter of the waveguides (Pi). This in turn sets the requirement on the spacing between waveguide channels given a configuration of atoms intended for interconnect operations (as shown in FIG. 12).

In certain aspects, the readout unit 850 may include one or more variable magnification telescope, with average magnification M r that is tunable by an amount 6M r.

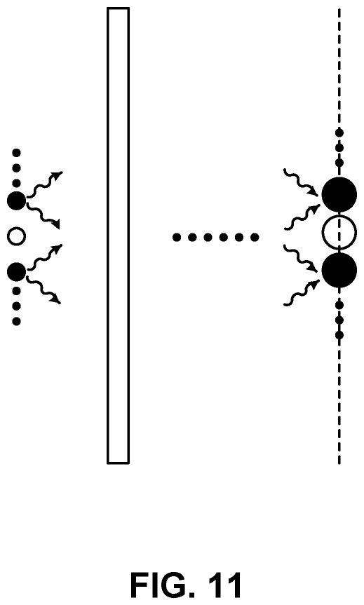

In some aspects, the one or more photodetectors 860 may be configured to captured the readout beam associated with the states of the trapped ions in the one or more atomic arrays 802. The one or more photodetectors 860 may capture the fluorescent light in the readout beam associated with the trapped ions. The one or more photodetectors 860 may analyze the characteristics of the fluorescent light to determine the states of the trapped ions. The one or more photodetectors 860 may include one or more devices (e.g. charge-coupled device, avalanche photodiode, etc.), which are characterized by an effective aperture (Aᵣ), pixel size (Pᵣ), and the desired number of used pixels (Nᵣ). The magnification Mᵣ is determined by the desired size of the image on the photodetector, which may be set by the condition that the image of adjacent atoms have negligible overlap while minimizing the number of pixels used (as shown in FIG. 11). The object size of atoms in a trap may be small compared to the resolution of microscope objectives, and so the PSF of the microscope objective may be used to specify this magnification. As before, the tunable magnification allows the optimization of the image size for varying distance between qubits, d.

In some aspects of the present disclosure, a single switch may be used to modulate the addressing beam, the readout beam, and the interconnect beam. The single switch may use a combination of frequency division multiplexing, time division multiplexing, and/or space division multiplexing to modulate the beams.

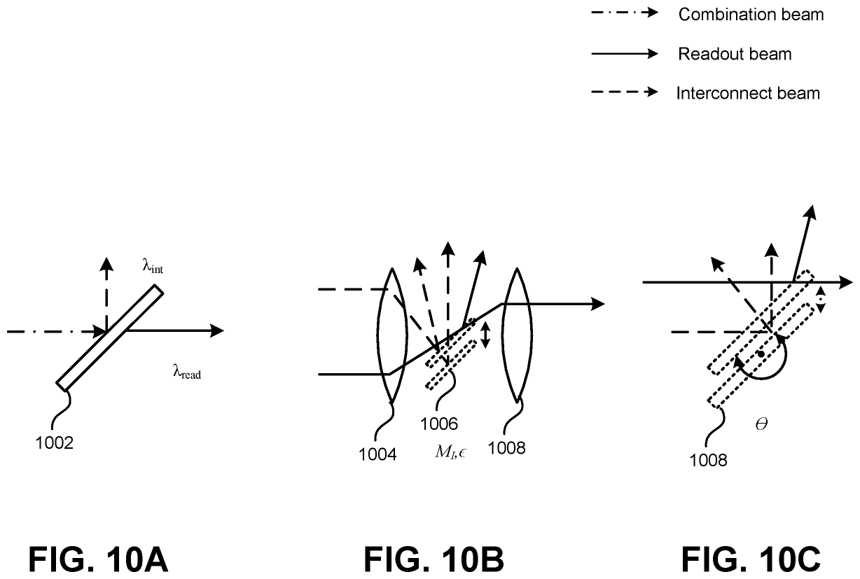

FIGS. 10A-C illustrate example schemes for multiplexing beams according to aspects of the present disclosure. Referring to FIGS. 9 and 10A-C, the second switch 830 can be configured to implement one or more of frequency division multiplexing, space division multiplexing, and/or time division multiplexing. FIG. 10A illustrates an example of frequency division multiplexing. The readout beam and the interconnect beam may impinge on a first mirror 1002 as a combination beam. Based on the frequency difference between the readout beam (λ_{read}) and the interconnect beam (λᵢₙₜ), the first mirror 1002 may guide the readout beam toward a first direction (e.g., toward the readout unit 850) and the interconnect beam toward a second direction (e.g., toward the interconnect unit 840).

FIG. 10B illustrates an example of space division multiplexing according to aspects of the present disclosure. The readout beam and the interconnect beam may be guided by a first lens 1004, a second mirror 1006, and/or an optional second lens 1008 to achieve space division multiplexing. The first lens 1004 may refract the readout beam and the interconnect beam toward different spatial locations. For example, the first lens 1004 may refract the interconnect beam toward the second mirror 1006 and the readout beam toward the optional second lens 1008. The second mirror 1006 may reflect the interconnect beam toward the second direction (e.g., toward the interconnect unit 840). The optional second lens 1008 may refract the readout beam toward the first direction (e.g., toward the readout unit 850). In an alternative implementation, the first lens 1004 may refract the interconnect beam and the readout beam toward the second mirror 1006. The second mirror 1006 may reflect the readout beam toward the first direction and the interconnect beam toward the second direction. Other configurations may also be implemented.

FIG. 10C illustrates an example of time division multiplexing according to aspects of the present disclosure. The readout beam and the interconnect beam may be guided by a third mirror 1008 at different times to implement time division multiplexing. For example, the interconnect beam may impinge on the third mirror 1008 at a first time. The third mirror 1008 (at the first time) may reflect the interconnect beam toward the second direction. The readout beam may impinge on the third mirror 1008 at a second time different than the first time. Prior to the second time, the third mirror 1008 may be shifted spatially and/or rotated such that, when the readout beam impinges on the third mirror 1008, the third mirror 1008 may reflect the readout beam toward the first direction. Other configurations may also be implemented.

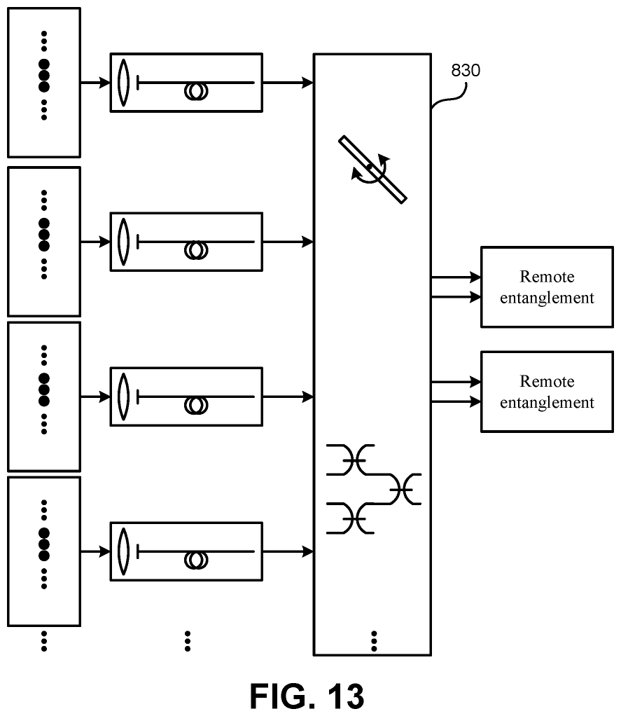

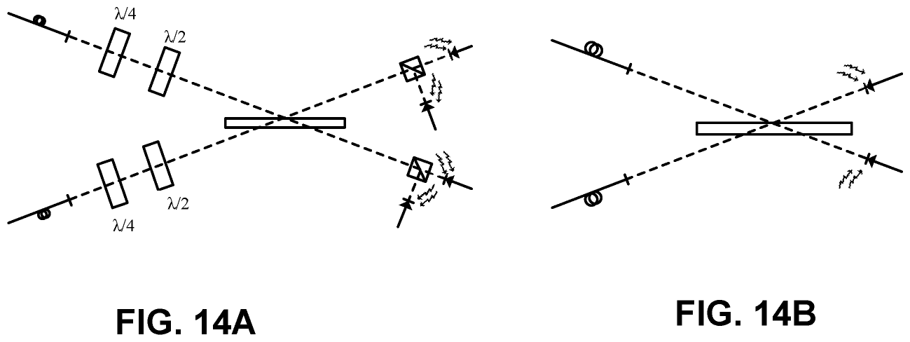

FIG. 13 illustrates an example of operation for routing interconnect beam by the second switch 830 according to aspects of the present disclosure. Referring to FIGS. 8-10, the second switch 830 may enable fluorescent photons collection via the interconnect unit 840 of the interconnect system 800 to be routed to units that implement remote entanglement among QPUs (not shown). These QPUs can reside inside the same vacuum chamber or separate chambers. The second switch 830 may be composed of a similar tip/tilt mirror as described for separating light intended for readout and interconnect operations. Alternatively or additionally, the second switch 830 may be a photonic quantum computer, which uses Mach-Zehnder interferometers etched into silicon waveguides to route photons along different paths. After routing, these photons are then sent to units which implement remote entanglement by interfering pairs of photons on 50/50 beam-splitters so that which-path information is erased. Example implementations of these units are illustrated in FIGS. 14A-B for photons with entanglement encoded in the, though not limited to, polarization and occupation degrees of freedom.

Referring to FIGS. 14A-B, which show example units to herald remote entanglement. A beam-splitter interferences fluorescent photons, erasing which path information. Photons are then detected either in a Bell-state Analyzer setup (a) or in a coincidence detection (b), depending on what degree of freedom of the photon is used for entanglement.

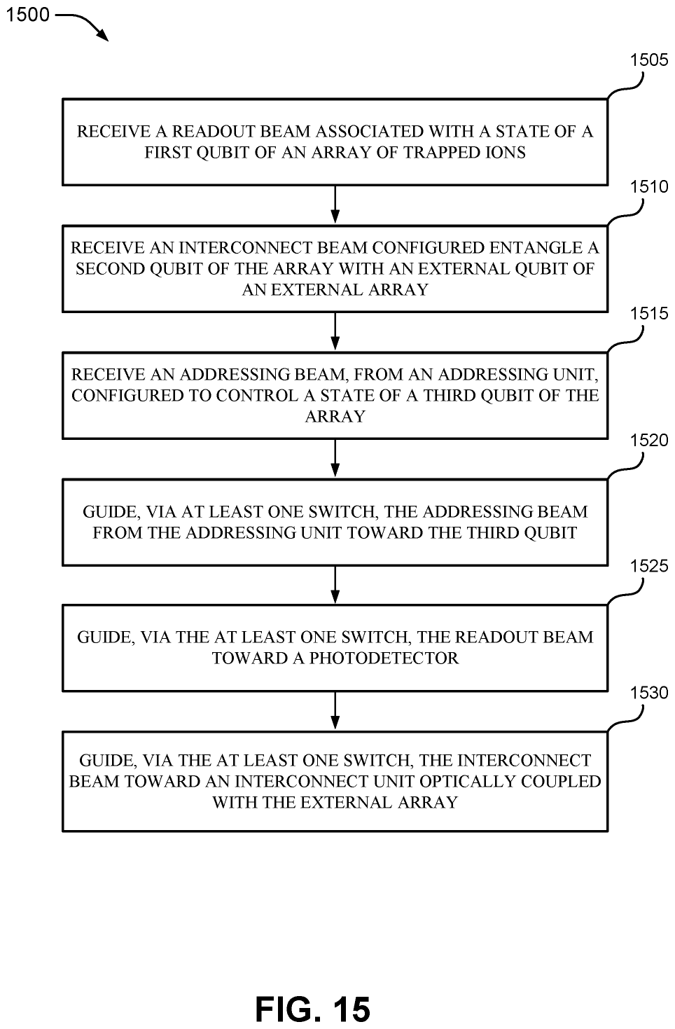

FIG. 15 illustrates a method 1500 for implementing remote entanglement according to aspects of the present disclosure. The 1500 method may be performed by one or more of the QIP system 200, the computer device 300, and/or the interconnect system 800, and/or one or more subcomponents thereof.

At 1505, the method 1500 may receive a readout beam associated with a state of a first qubit of an array of trapped ions. For example, the optical component 810, the first switch 820, the second switch 830 and/or the interconnect system 800 may receive the readout beam from the one or more atomic arrays 802.

At 1510, the method 1500 may receive an interconnect beam configured entangle a second qubit of the array with an external qubit of an external array. For example, the optical component 810, the first switch 820, the second switch 830 and/or the interconnect system 800 may receive the interconnect beam configured to entangle a qubit of the one or more atomic arrays 802 with a qubit in another QPU.

At 1515, the method 1500 may receive an addressing beam, from an addressing unit, configured to control a state of a third qubit of the array. For example, the first switch 820, the second switch 830 and/or the interconnect system 800 may receive the addressing beam from the addressing unit 822.

At 1520, the method 1500 may guide, via at least one switch, the addressing beam from the addressing unit toward the third qubit. For example, the general controller 205, the optical and trap controller 220, the QIP system 200, the processor 310, the memory 320, the user interface 350, the operating system 360, the computer device 300, the switch 820, the second switch 830, and/or the interconnect system 800 may guide the addressing beam toward the one or more atomic arrays 802.

At 1525, the method 1500 may guide, via the at least one switch, the readout beam toward a photodetector. For example, the general controller 205, the optical and trap controller 220, the QIP system 200, the processor 310, the memory 320, the user interface 350, the operating system 360, the computer device 300, the switch 820, the second switch 830, and/or the interconnect system 800 may guide the readout beam toward the readout unit 850 and/or the one or more photodetectors 860.

At 1530, the method 1500 may guide, via the at least one switch, the interconnect beam toward an interconnect unit optically coupled with the external array. For example, the general controller 205, the optical and trap controller 220, the QIP system 200, the processor 310, the memory 320, the user interface 350, the operating system 360, the computer device 300, the switch 820, the second switch 830, and/or the interconnect system 800 may guide the interconnect beam toward the interconnect unit 840.

Aspects of the present disclosure include a method for receiving a readout beam associated with a state of a first qubit of an array of trapped ions, receiving an interconnect beam configured entangle a second qubit of the array with an external qubit of an external array, receiving an addressing beam, from an addressing unit, configured to control a state of a third qubit of the array, guiding, via at least one switch, the addressing beam from the addressing unit toward the third qubit, guiding, via the at least one switch, the readout beam toward a photodetector, and guiding, via the at least one switch, the interconnect beam toward an interconnect unit optically coupled with the external array.

Aspects of the present disclosure include the method above, further comprising receiving the readout beam and the interconnect beam via a viewport.

Aspects of the present disclosure include any of the methods above, further comprising multiplexing the addressing beam and a combination of the readout beam and the interconnect beam via frequency division multiplexing.

Aspects of the present disclosure include any of the methods above, further comprising multiplexing the readout beam and the interconnect beam via frequency division multiplexing.

Aspects of the present disclosure include any of the methods above, further comprising multiplexing the readout beam and the interconnect beam via time division multiplexing.

Aspects of the present disclosure include any of the methods above, further comprising multiplexing the readout beam and the interconnect beam via space division multiplexing.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for remotely entangling quantum processing units (QPUs), comprising:
receiving a readout beam associated with a state of a first qubit of an array of trapped ions;
receiving an interconnect beam configured to entangle a second qubit of the array with an external qubit of an external array;
receiving an addressing beam, from an addressing unit, configured to control a state of a third qubit of the array;
guiding, via at least one switch, the addressing beam from the addressing unit toward the third qubit;
guiding, via the at least one switch, the readout beam toward a photodetector; and
guiding, via the at least one switch, the interconnect beam toward an interconnect unit optically coupled with the external array.

2. The method of claim 1, further comprising receiving the readout beam and the interconnect beam via a viewport.

3. The method of claim 1, further comprising multiplexing the addressing beam and a combination of the readout beam and the interconnect beam via frequency division multiplexing.

4. The method of claim 1, further comprising multiplexing the readout beam and the interconnect beam via frequency division multiplexing.

5. The method of claim 1, further comprising multiplexing the readout beam and the interconnect beam via time division multiplexing.

6. The method of claim 1, further comprising multiplexing the readout beam and the interconnect beam via space division multiplexing.

7. An interconnect system for remotely entangling quantum processing units (QPUs), comprising:
an array of trapped ions;
an addressing unit configured to transmit an addressing beam;
at least one switch configured to:
receive a readout beam associated with a state of a first qubit of the array of trapped ions;
receive an interconnect beam configured entangle a second qubit of the array with an external qubit of an external array;
receive, from the addressing unit, the addressing beam configured to control a state of a third qubit of the array;
guide the addressing beam from the addressing unit toward the third qubit;
guide the readout beam toward a photodetector; and
guide the interconnect beam toward an interconnect unit;
the interconnect unit configured to optically couple with the external array; and
the photodetector configured to capture light emitted from the readout beam.

8. The interconnect system of claim 7, further comprising a vacuum chamber, wherein the array of trapped ions is disposed within the vacuum chamber.

9. The interconnect system of claim 8, further comprising a viewport disposed between the array of trapped ions and the at least one switch.

10. The interconnect system of claim 9, further comprising an optical component disposed between the viewport and the at least one switch.

11. The interconnect system of claim 10, wherein the optical component includes a microscope objective.

12. The interconnect system of claim 7, wherein the addressing unit includes a variable magnification telescope.

13. The interconnect system of claim 7, further comprising a readout unit disposed between the at least one switch and the photodetector.

14. The interconnect system of claim 13, wherein the readout unit includes a variable magnification telescope.

15. The interconnect system of claim 7, wherein the photodetector includes a charge-coupled device or an avalanche photodiode.

16. The interconnect system of claim 7, wherein the at least one switch includes a first switch configured to multiplex the addressing beam and a combination of the readout beam and the interconnect beam via a first mirror.

17. The interconnect system of claim 16, wherein:
the at least one switch includes a second switch configured to receive the combination of the readout beam and the interconnect beam; and
the second switch includes a second mirror configured to multiplex the readout beam and the interconnect beam.

18. The interconnect system of claim 16, wherein:
the at least one switch includes a second switch configured to receive the combination of the readout beam and the interconnect beam; and
the second switch includes a moveable mirror and a lens, the second switch being configured to multiplex the readout beam and the interconnect beam via the moveable mirror and the lens.

19. The interconnect system of claim 16, wherein:
the at least one switch includes a second switch configured to receive the combination of the readout beam and the interconnect beam; and
the second switch includes a rotatable mirror and a lens, the second switch being configured to multiplex the readout beam and the interconnect beam via the rotatable mirror and the lens.

20. The interconnect system of claim 7, wherein the interconnect unit includes one or more of a waveguide, fiber coupling lenses, or fibers.
